(19) United States
(12) Patent Application Publication
(10) Pub. No.: US 2009/0058118 A1
(43) Pub. Date: Mar. 5, 2009

(54) Trim panel for a motor vehicle and method of manufacturing

(75) Inventors: David Hein, Sterling Heights, MI (US); Roger Knutson, Sterling Heights, MI (US)

Correspondence Address: MACMILLAN, SOBANSKI & TODD, LLC, ONE MARITIME PLAZA-FIFTH FLOOR, 720 WATER STREET, TOLEDO, OH, 43604, US

(73) Assignee: Lear Corporation

(21) Appl. No.: 11/897,555

(22) Filed: Aug. 31, 2007

(51) Int. Cl. B62D 25/08; H01H 9/00; H01L 21/02

(52) U.S. Cl. 296/1.08; 438/51; 200/310

(57) ABSTRACT

An interface for an interior trim component in a motor vehicle includes a fascia formed from wood veneer.

### BACKGROUND

Various embodiments of a trim panel for a vehicle are described herein. In particular, the embodiments described herein relate to an improved interface for a trim panel of a motor vehicle.

A conventional interface for a motor vehicle typically includes a switch or a switch array, which generally comprises a large number of switches mounted in and around interior trim components such as armrests, consoles, and/or the instrument panel of the motor vehicle. Conventionally, motor vehicles employ mechanical switches, which have physically moving (e.g., sliding) parts that create contact between conductors. Openings are provided in the interior trim components of the motor vehicle for receiving the switches. The openings commonly attract dust and dirt. This dust and dirt is difficult to reach. Consequently, the interior trim component is difficult to clean.

Additionally, the physical characteristics of the switches usually occupy space (i.e., usually about 0.5 to 5 mm) for the mechanical movement of the switches. This limits the ability to style and craft the interior trim component. The switches are also subject to wear and mechanical breakdown due to the moving parts of the switches and thus may become unreliable.

Openings in the interior trim components for the switches require increased cut lines during the production of the interior trim components and the unique character of each of the switches may require an increased number of parts. The large number of switches and openings may not be esthetically pleasing to some vehicle operators and passengers.

### SUMMARY

The present application describes various embodiments of an interface for an interior trim component in a motor vehicle. One embodiment of the interface includes a fascia formed from wood veneer.

Another embodiment of the interface includes a fascia formed from metallized plastic.

Other advantages of the interface will become apparent to those skilled in the art from the following detailed description, when read in light of the accompanying drawings.

### BRIEF DESCRIPTION OF THE DRAWINGS

FIG. 1 is a perspective view of a first embodiment of an improved vehicle interior trim component.

FIG. 2 is a perspective view of the vehicle interior trim component illustrated in FIG. 1 showing the switches and indicia illuminated in the fascia.

FIG. 2A is an enlarged view of a portion of the fascia of the vehicle interior trim component illustrated in FIG. 2.

FIG. 3 is a schematic view in section of the interface shown in FIGS. 1 and 2.

FIG. 4 is a flow chart of a method of manufacturing an interface.

### DETAILED DESCRIPTION

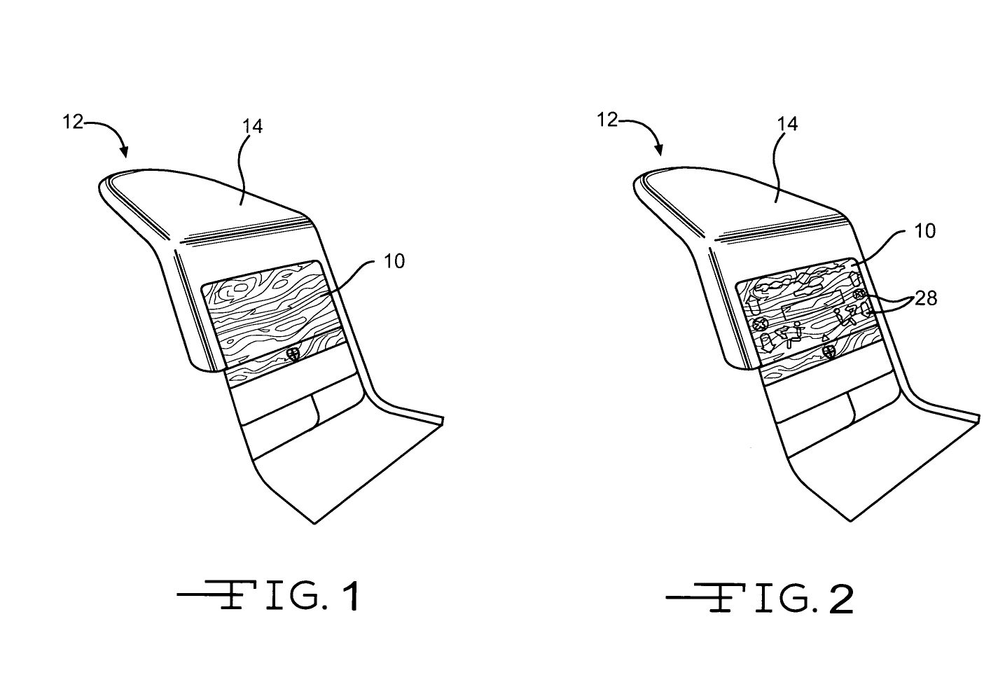

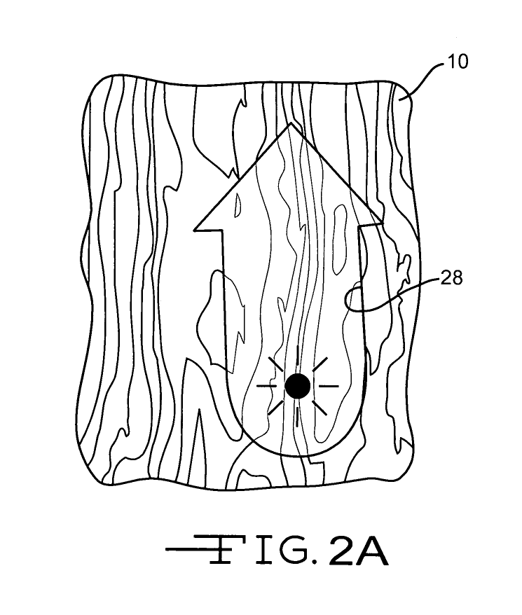

Referring now to the drawings, there is illustrated in FIGS. 1 and 2 a motor vehicle interior trim component 12, including an interface indicated generally at 10. The interior trim component 12 supports back-lighted indicia and switch or switch array, herein defined as a plurality of switches, that is operable to actuate and de-actuate or stop one or more electrically operated devices (not shown) of the vehicle. Examples of such devices include the driver's and passenger's heated seat, hazard lights, rear window defogger, climate control system, radio, and other entertainment systems.

In the embodiment illustrated in FIGS. 1 and 2, the trim component 12 includes a trim component body 14 having the interface 10 attached thereto. In the illustrated embodiments, the trim component 12 is shown as a center console. It will be understood however, that the trim component 12 may be any desired vehicle interior trim component, such as for example, an instrument panel (not shown), a door panel (not shown), an overhead panel (not shown), and the like. The trim component body 14 may be made of any suitable material, such as a plastic-based material, that is molded or otherwise crafted as desired to produce a substantially rigid structure having a desired shape and style. The molding and manufacture of interior trim components such as the body 14 is well known to those of ordinary skill in the art described herein and thus will not be described in further detail.

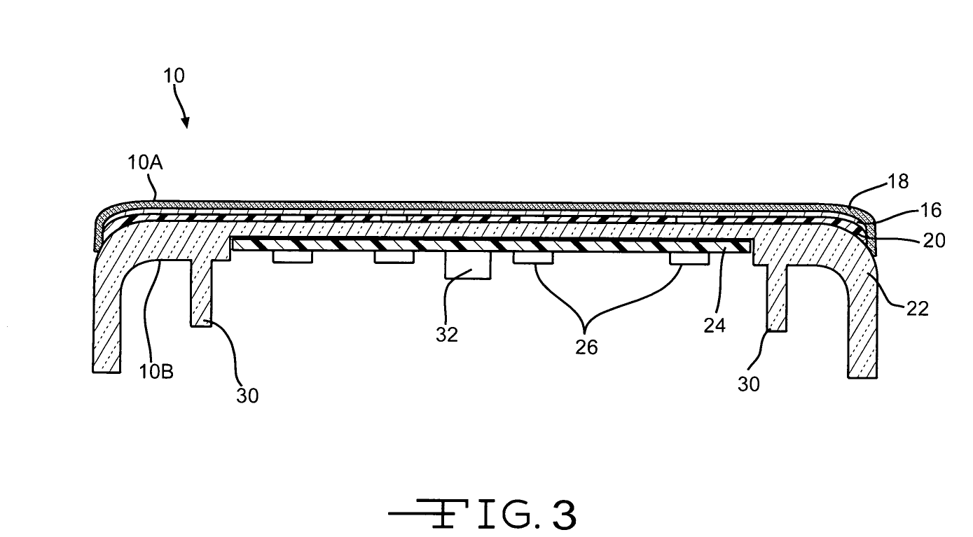

Referring now to FIG. 3, a first embodiment of the interface is indicated generally at 10. The interface 10 includes a vehicle occupant-facing side or A-side 10A and a B-side 10B opposite the A-side 10A. In the embodiment illustrated in FIG. 3, the interface 10 includes a face plate or fascia 16, and one or more layers of lacquer 18 on the A-side surface thereof. An appliqué layer 20 may be bonded to the B-side surface of the fascia 16. The appliqué layer 20 may include open areas 28 as described in detail herein below.

In the embodiment illustrated, the fascia 16, with the lacquer layer 18 and appliqué layer 20, are suitably attached to a substrate 22. A printed circuit board (PCB) 24 with suitable light sources 26 may be attached to the substrate 22 such that the light from the light sources 26 is directed through the substrate 22 toward the fascia 16. It will be understood that at least a portion of the substrate 22 will be formed of transparent material so that the light from the light sources 26 may travel through the substrate 22 and the open areas 28 in the appliqué layer 20.

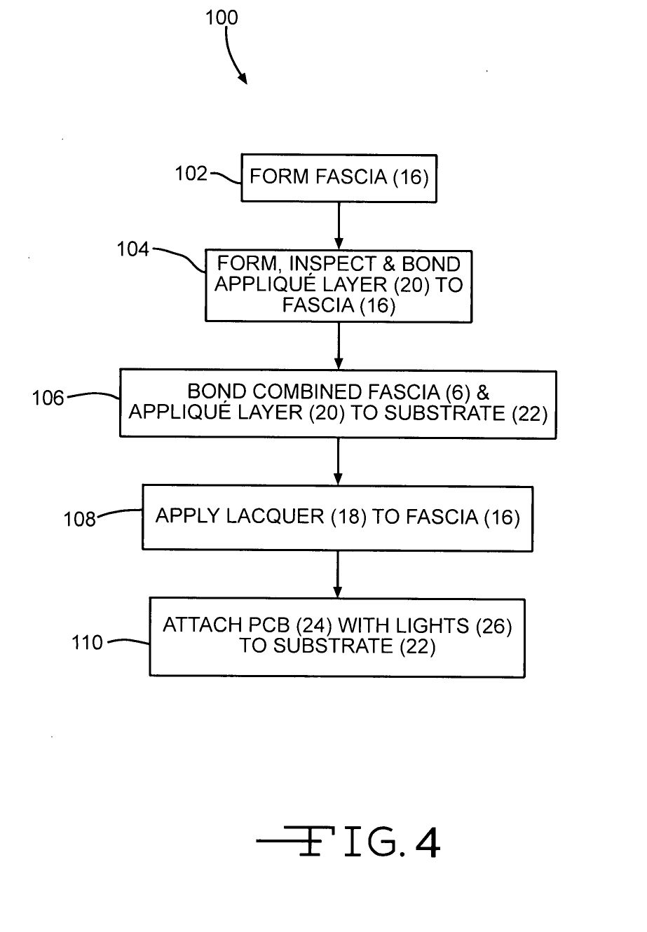

A flow chart representing a first embodiment of the method of manufacturing the trim component 12 is illustrated generally at 100 in FIG. 4. As illustrated, in a first step 102 of the method 100, the fascia 16 is formed. The fascia 16 may be formed from a very thin layer of wood or wood veneer, such as for example, birds eye maple, sycamore English flat cut, and Carpathian elm burl. Any other wood may also be used. In one embodiment of the fascia 16, the wood veneer has a thickness within the range of from about 0.0005 inch to about 0.020 inch. In a second embodiment of the fascia 16, the wood veneer has a thickness within the range of from about 0.001 inch to about 0.010 inch. In a third embodiment of the fascia 16, the wood veneer has a thickness within the range of from about 0.001 inch to about 0.003 inch. Alternatively, the fascia 16 may be formed from metallized or decorated plastic, such as for example, polycarbonate film having a coating of aluminum. Such decorated or metallization can be accomplished by any known technique, such asvacuum metallization, plating, flame or arc spraying, and painting. It will be understood that the fascia 16 may also be formed from any other desired material, such as other plastic or resin, metals, metal alloys, other non-metals, and other natural materials.

In a second step 104 of the method 100, the appliqué layer 20 is formed and bonded to the fascia 16. The illustrated appliqué layer 20 is an opaque material having open areas 28 for indicia, such as for example the radio and climate control indicators shown in FIGS. 1 and 2. The appliqué layer 20 may include any desired number open areas 28 formed anywhere where light is desired to be transmitted from a light source 26 through the appliqué layer 20 to the fascia 16. The appliqué layer 20 may be bonded to the fascia 16 by any desired means, such as pressure sensitive adhesive or a thin layer of conventional adhesive. In the embodiments illustrated and described herein, the bonding of the appliqué layer 20 to the fascia 16 improves the structural integrity of the fascia 16.

In the illustrated embodiment, the appliqué layer 20 is formed from a polycarbonate film with graphics or indicia. Alternatively, the appliqué layer 20 may be formed through a masked paint operation where the paint forms the opaque regions or portions about the graphics or indicia. Any other suitable material may also be used. In one embodiment of the appliqué layer 20, the layer 20 has a thickness within the range of from about 0.010 inch to about 0.080 inch. In a second embodiment of the appliqué layer 20, the layer 20 has a thickness within the range of from about 0.002 inch to about 0.010 inch. In a third embodiment of the appliqué layer 20, the layer 20 has a thickness of about 0.015 inch.

During the second step 104, the appliqué layer 20 may be positioned and aligned to the fascia 16 on a light table (not shown), so that an assembler/operator may inspect the fascia 16 for undesirable pin holes through which undesired light may travel. The location or placement of the appliqué may be adjusted such that the pin holes are covered by the opaque portion of the appliqué.

In a third step 106 of the method 100, the fascia 16 with the appliqué layer 20 bonded thereto, is attached to the substrate 22. In one embodiment of the third step 106, the fascia 16 and appliqué layer 20 are insert molded with the substrate 22. It will be understood that the fascia 16 and appliqué layer 20 may be attached or bonded to the substrate 22 by any other desired method, such as with adhesive or by mechanical attachment, such as with screws, clips, and the like.

In the illustrated embodiment, the substrate 22 is formed from transparent plastic, such as for example polycarbonate. Any other suitable material may also be used, such as other transparent plastics and non-plastics, and other substantially transparent plastics and non-plastics. In one embodiment of the substrate 22, the substrate 22 has a thickness within the range of from about 0.080 inch to about 0.120 inch. It will be understood that the substrate 22 may also have any other desired thickness. As shown in FIG. 3, the substrate 22 may include any desired features, such as bosses 30 or other attachment features (not shown) for attaching the substrate 22 to a portion of a vehicle, such as the trim component 12.

In a fourth step 108 of the method 100, lacquer 18 is applied to the A-side of the fascia 16. In one embodiment of the fourth step 108, a plurality of layers of lacquer is applied. Each layer of lacquer is sanded after application. It will be understood that any desired number of layers of lacquer may be applied to form the lacquer layer 18. In one embodiment of the fascia 16, the lacquer layer 18 has a thickness of about 0.020 inch. It will be understood that the lacquer layer 18 may also have any other desired thickness. It will be further understood that one skilled in the art will be able to determine the appropriate thickness of the lacquer layer 18 through routine experimentation. The lacquer layer 18 protects the wood veneer of the fascia 16, but allows the character of the wood veneer to show-through to the interior of the vehicle so as to be esthetically pleasing to a vehicle occupant.

In a fifth step 110 of the method 100, a PCB 24 with one or more sources of light is suitably attached to the B-side of the substrate 22. If desired, the PCB 24 may be formed from a flexible material so that the PCB 24 may conform closely to the shape of the fascia 16 and/or the substrate 22. Such a flexible PCB 24 may be located very close to the B-side of the substrate 22. In one embodiment, the PCB 24 has a thickness within the range of from about 0.015 inch to about 0.062 inch. In a second embodiment, the PCB 24 has a thickness of about 0.032 inch.

It will be understood that the PCB 24 may include any desired electronic device, such as a switch, illustrated schematically at 32 in FIG. 3. Examples of switches include, but are not limited to, resistive, inductive, piezoelectric, and capacitive switches, and audio and/or tactile indicators to indicate the activation and/or deactivation of switches. The switches 32 may be any desired switches, such as the switches described in U.S. Pat. Nos. 7,136,051 and 7,015,407. The descriptions of the switches in U.S. Pat. No. 7,136,051 and 7,015,407 are incorporated herein by reference.

As shown in the illustrated embodiments, during operation of a motor vehicle the indicia 28 in the interface 10 may not be visible such that the interface appears opaque, as shown in FIG. 1. When it is desired for the indicia 28 to be visible to a vehicle operator or occupant, such as when the switch 32 is actuated, light from the light source 26 is visible through the fascia 16 of the interface 10, as shown in FIGS. 2 and 2A.

It will therefore be understood that the indicia 28 of the exemplary embodiments illustrated may be visible for only a portion of the time that a motor vehicle is in operation. When the indicia 28 are not visible, the interface 10 appears opaque and only the wood grain of the fascia 16 is visible. It will be further understood that when material other than wood or wood veneer, such as for example metallized or decorated plastic, is used as the fascia 16, such material will also appear opaque during a portion of the time that a motor vehicle is in operation. Further, when the fascia 16 is formed from such other material, the indicia 28 may be visible for only a portion of the time that the motor vehicle is in operation.

The principle and mode of operation of the interface have been described in its various embodiments. However, it should be noted that the interface described herein may be practiced otherwise than as specifically illustrated and described without departing from its scope.

What is claimed is:

1. An interface for an interior trim component in a motor vehicle, the interface comprising a fascia formed from wood veneer.

2. The interface according to claim 1, wherein the interface includes a first operating condition wherein indicia are visible in the fascia, and a second operating condition wherein the indicia are not visible in the fascia.

3. The interface according to claim 1, wherein the fascia has a thickness within the range of from about 0.0005 inch to about 0.020 inch.

4. The interface according to claim 1, further including an appliqué layer bonded to a B-side surface of the fascia.

5. The interface according to claim 4, wherein the appliqué layer is formed from polycarbonate film.

6. The interface according to claim 5, wherein the appliqué layer has a thickness within the range of from about 0.010 inch to about 0.080 inch.

7. The interface according to claim 4, further including a substrate bonded to one of the fascia and the appliqué layer.

8. The interface according to claim 7, wherein the substrate is formed from a substantially transparent material.

9. The interface according to claim 8, wherein the substrate has a thickness within the range of from about 0.080 inch to about 0.120 inch.

10. The interface according to claim 7, further including a layer of lacquer applied to an A-side surface of the fascia, wherein the layer of lacquer has a thickness of about 0.020 inch.

11. The interface according to claim 6, further including a printed circuit board bonded to a B-side surface of the substrate.

12. The interface according to claim 11, wherein the printed circuit board has a thickness within the range of from about 0.015 inch to about 0.062 inch.

13. The interface according to claim 11, wherein the printed circuit board is formed of flexible material.

14. The interface according to claim 11, wherein the printed circuit board further includes a source of light operatively attached thereto.

15. An interface for an interior trim component in a motor vehicle, the interface comprising a fascia formed from metallized plastic.

16. The interface according to claim 12, wherein the fascia has a thickness within the range of from about 0.0005 inch to about 0.020 inch.

17. A method of manufacturing an interface for an interior trim component in a motor vehicle, the method comprising the steps of:
a. forming a fascia from wood veneer having a thickness within the range of from about 0.0005 inch to about 0.020 inch;
b. forming and bonding an appliqué layer to a B-side surface of the fascia;
c. forming a substrate and bonding the combined fascia and appliqué layer to the substrate;
d. applying a layer of lacquer to an A-side surface of the fascia; and
e. attaching a printed circuit board to a B-side surface of the substrate.

18. The method according to claim 17, wherein in step (c) the combined fascia and appliqué is integrally formed with substrate by an insert molding process.

19. The method according to claim 17, wherein in step (e) the printed circuit board includes a source of light operatively attached thereto.

20. The method according to claim 17, wherein in step (e) the printed circuit board is formed of flexible material.
